(19) United States
(12) Patent Application Publication
(10) Pub. No.: US 2022/0022425 A1
(43) Pub. Date: Jan. 27, 2022

(54) PET ACCESSORY

(71) Applicant: Mark Keith ASHLIN, Applecross, Western Australia (AU)

(72) Inventors: Mark Keith Ashlin, Western Australia (AU); James Eadie, Western Australia (AU)

(21) Appl. No.: 17/276,994

(22) PCT Filed: Sep. 25, 2019
(86) PCT No.: PCT/AU2019/051027

§ 371 Date: Mar. 17, 2021

(51) Int. Cl. A01K 27/00; A01K 15/02

(52) U.S. Cl. CPC A01K 27/008; A01K 27/003; A01K 15/025

(57) ABSTRACT

Provided is a pet accessory comprising a leash having a distal end configurable to engage an animal and further defining a finger loop, with a proximal end defining a handle. Also included is an elastic resiliently deformable cradle shaped and configured for operatively receiving a ball therein, the cradle configured so that the leash is slidably receivable through at least a portion of an outer periphery thereof so that folding the leash about the outer periphery engages the ball in the cradle, wherein the pet accessory is usable to lead an animal and as a sling to cast the ball.

### CROSS-REFERENCE TO RELATED APPLICATIONS

This application is a national phase entry under 35 U.S.C. § 371 of International Patent Application PCT/AU2019/051027, filed Sep. 25, 2019, designating the United States of America and published as International Patent Publication WO 2020/061625 A1 on Apr. 2, 2020, which claims the benefit under Article 8 of the Patent Cooperation Treaty to Australian Patent Application Serial No. 2018903590 filed Sep. 25, 2018.

### TECHNICAL FIELD

This disclosure relates to the field of keeping pets, in general, and more specifically to a pet accessory, typically an accessory and toy for a dog.

### BACKGROUND ART

The following discussion of the background art is intended to facilitate an understanding of the disclosure only. The discussion is not an acknowledgement or admission that any of the material referred to is or was part of the common general knowledge as at the priority date of the application.

A pet or companion animal is an animal kept primarily for company, protection, or entertainment rather than as a working animal, livestock, or laboratory animal. Pets provide their owners both physical and emotional benefits. For example, walking a dog can supply both the human and pet with exercise, fresh air, and social interaction.

Pets can give companionship to elderly adults who do not have adequate social interaction with other people, as well as to other people who are living alone. There is a medically approved class of therapy animals, mostly dogs or cats, that are brought to visit confined humans, such as children in hospitals or the elderly in nursing homes. Pet therapy utilizes trained animals and handlers to achieve specific physical, social, cognitive, and emotional goals with patients. Some of the most popular pets are likely dogs and cats, but other animals are also kept as pets, such as birds, reptiles, etc. The archaeological record shows the first undisputed dog remains buried beside humans dated around 14,700 years ago, with disputed remains occurring around 36,000 years ago. Accordingly, a large number of people keep dogs as pets worldwide.

Studies have shown that there are health benefits to keeping a pet. For example, when in the presence of a pet dog, people show reductions in cardiovascular, behavioral and psychological indicators of anxiety. Other health benefits are gained from exposure to immune-stimulating microorganisms, which, according to the so-called hygiene hypothesis, can protect against allergies and autoimmune diseases. The benefits of contact with, for example, a dog also include social support, as dogs are able to not only provide companionship and social support themselves, but also to act as facilitators of social interactions between humans.

The practice of using dogs and other animals as a part of therapy dates back to the late 18th century, when animals were introduced into mental institutions to help socialize patients with mental disorders. Animal-assisted intervention research has shown that animal-assisted therapy with a dog can increase social behaviors, such as smiling and laughing, among people with Alzheimer's disease. One study demonstrated that children with ADHD and conduct disorders who participated in an education program with dogs and other animals showed increased attendance, increased knowledge and skill objectives, and decreased antisocial and violent behavior compared with those who were not in an animal-assisted program.

As such, an important aspect to keeping a pet, such as a dog or cat, is beneficial interaction therewith. Numerous games or means to interact with and entertain both pets and owners have been developed during human history.

For example, many dogs are natural retrievers that enjoy retrieving objects such as sticks or balls. Unfortunately, the stick or ball is typically thrown at great distances for long periods of time, which often makes a person's back and arm tired before the animal is ready to rest. To address this problem, ball-throwing apparatus has been developed, such as disclosed in U.S. Pat. No. 6,076,829. One shortcoming with such prior art devices is that they are bulky, cumbersome and serve no other purpose than throwing a ball, requiring a pet owner to carry such apparatus around with them when they are needed.

Applicant has devised the following disclosure that facilitates interaction, exercise and entertainment of pets, especially dogs, in a manner which is beneficial to both pet and owner and in amelioration of the shortcomings in the art of ball-throwing apparatus.

### BRIEF SUMMARY

It is to be appreciated by the skilled addressee that reference herein to a “pet” generally includes reference to a dog, but the disclosure is not limited solely to dogs and is usable by other pet animals, e.g., cats, ferrets, or any other animals where there is a want or need for throwing an object for the entertainment and/or exercise of such animal.

According to a first aspect of the disclosure, there is provided a pet accessory comprising:
a leash having a distal end configurable to engage an animal and further defining a finger loop, a proximal end defining a handle; and
an elastic resiliently deformable cradle shaped and configured for operatively receiving a ball therein, the cradle configured so that the leash is slidably receivable through at least a portion of an outer periphery thereof so that folding the leash about the periphery engages the ball in the cradle, wherein the accessory is usable to lead an animal and as a sling to cast the ball.

The skilled addressee will appreciate that by the cradle being slidably arranged on the leash allows the cradle to be moved to either the proximal or distal ends of the leash in order to function as a ball carrier when the accessory is used as a leash. The cradle is similarly moveable to a central portion of the leash, as required, when the leash is used as a sling.

Typically, the distal end is configurable to engage an animal by including a leash clip.

In one embodiment, the distal end is configurable to engage an animal by defining an aperture for fitment around a neck of an animal.

Typically, the finger loop is shaped and dimensioned to operatively receive a finger of a user therein in order to secure the accessory to a user's hand to facilitate casting the ball as a sling.

Typically, the finger loop is positioned on the leash so that the leash clip lies and is comfortably graspable in a palm of a user's hand while a finger on the hand is received by the finger loop.

Typically, the handle comprises a wrist loop through which a wrist of a user is operatively passable.

Typically, the handle is shaped and dimensioned to be comfortably graspable by a thumb of the user while the leash clip lies and is comfortably graspable in a palm of a user's hand while an index finger on the hand is received by the finger loop in order to facilitate usability as a sling.

Typically, the cradle is manufactured from a polymer and/or rubber material.

Typically, the cradle is shaped and dimensioned to provide an interference fit to a conventional ball, such as a tennis ball, a squash ball, etc.

Typically, the cradle is shaped and dimensioned to provide an interference fit to a plurality of conventional balls, such as a tennis ball, a squash ball, a golf ball, etc.

Typically, the outer periphery of the cradle defines at least two slits therein so that the leash is slidably receivable therethrough.

Typically, the leash includes a stopper configured to retain the cradle at a certain position along a length of the leash. The stopper may be adjustable.

Typically, the leash includes a securing means, such as a suitable strap, configured to secure the ball in the cradle.

In one embodiment, the securing means includes interference fit fasteners whereby the securing means is fixable to the leash to either retain the ball in the cradle, or to secure the securing means out of the way when the leash is used as a sling. Such interference fit fasteners may include press studs, buttons, hook and loop fasteners, or the like.

The disclosure also extends in a further aspect thereof to a pet accessory comprising an elastic resiliently deformable cradle shaped and configured for operatively receiving a ball therein, the cradle configured so that a leash is operatively slidably receivable through at least a portion of an outer periphery thereof so that folding the leash about the periphery engages the ball in the cradle, wherein the accessory is usable to lead an animal and as a sling to cast the ball.

The skilled addressee will appreciate that such a cradle is retrofittable to an existing leash, as described herein.

### BRIEF DESCRIPTION OF THE DRAWINGS

The description will be made with reference to the accompanying drawings in which:

FIG. 1 is a perspective view diagrammatic representation of one embodiment of a pet accessory in accordance with an aspect of the disclosure;

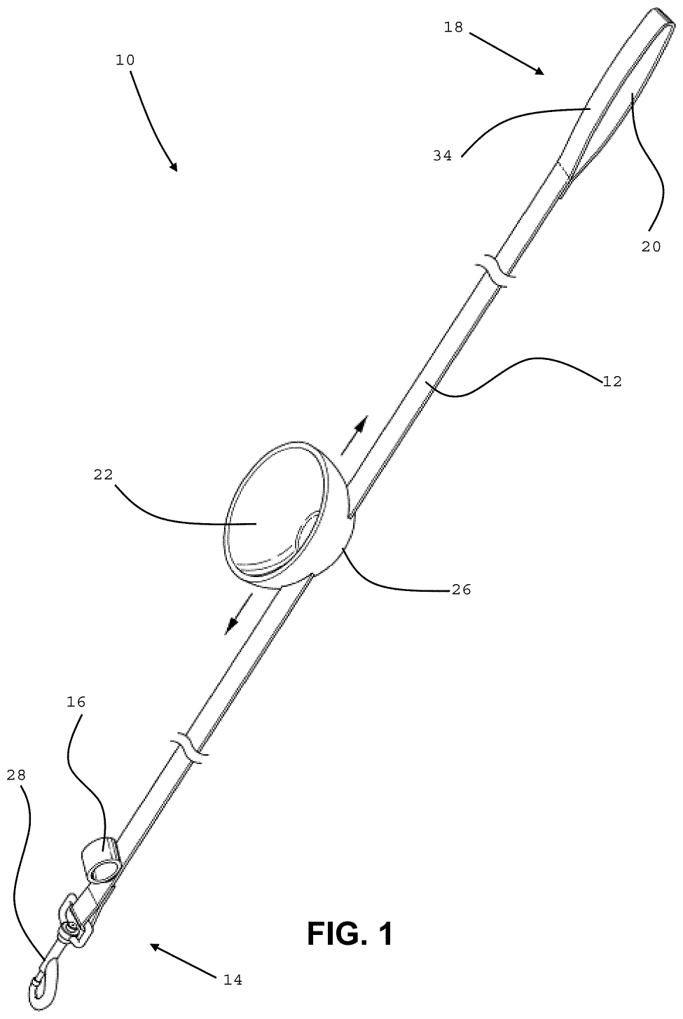

FIG. 2 is a perspective view diagrammatic representation of the pet accessory of FIG. 1 showing the leash folded about a periphery of the cradle to engage a ball;

FIG. 3 is a close-up side sectional diagrammatic representation of the cradle showing the leash slidably received through the outer periphery thereof;

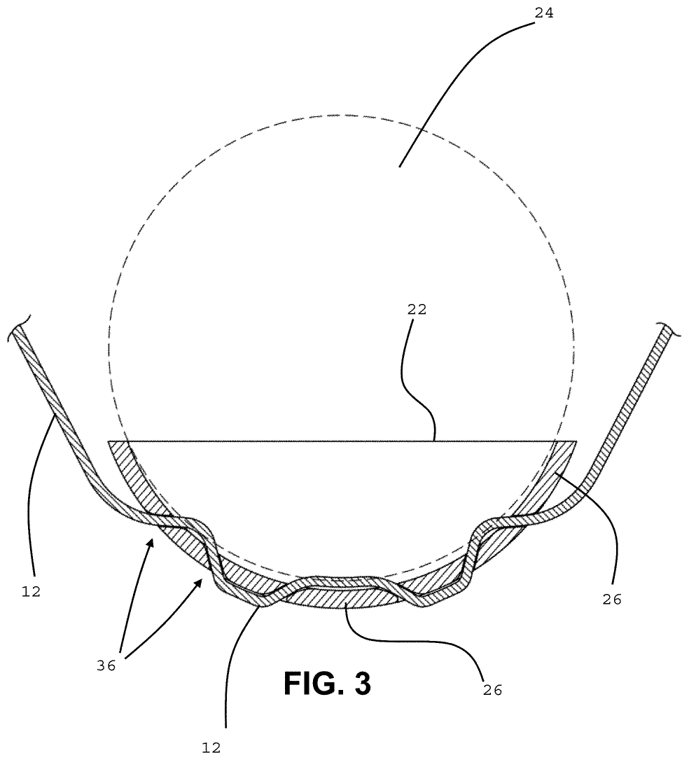

FIG. 4 is a perspective view diagrammatic representation of a user's hand showing the leash clip lying in a palm thereof while a finger is received by the finger loop;

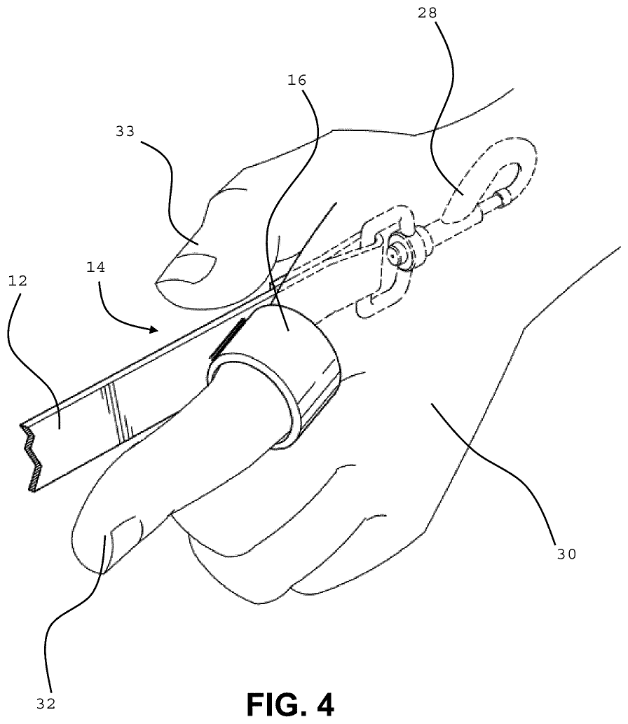

FIG. 5 is a perspective view diagrammatic representation of another embodiment of a pet accessory, in accordance with an aspect of the disclosure, having a securing means and stopper;

FIG. 6 is a perspective view diagrammatic representation of the pet accessory of FIG. 5 showing the securing means and stopper in use;

FIG. 7 is a close-up side sectional diagrammatic representation of the cradle of the embodiment of FIG. 5 showing the leash slidably received through the outer periphery thereof;

FIGS. 8A and 8B are perspective view diagrammatic representations of another embodiment of a pet accessory, in accordance with an aspect of the disclosure, having a securing means; and

FIGS. 9A and 9B are perspective view diagrammatic representations of a stopper for the pet accessory.

### DETAILED DESCRIPTION

Further features of the disclosure are more fully described in the following description of several non-limiting embodiments thereof. This description is included solely for the purposes of exemplifying the disclosure to the skilled addressee. It should not be understood as a restriction on the broad summary, disclosure or description as set out above. In the figures, incorporated to illustrate features of the example embodiment or embodiments, like reference numerals are used to identify like parts throughout.

Referring now to the accompanying drawings, there is shown one possible embodiment of a pet accessory 10 generally comprising a leash 12 and an elastic resiliently deformable cradle 22. The leash 12 typically has a distal end 14 configurable to engage an animal, like a dog, and further defining a finger loop 16, as shown. The leash 12 also has a proximal end 18 defining a handle 20.

The pet accessory 10 includes the elastic resiliently deformable cradle 22, which is generally shaped and configured for operatively receiving a ball 24 therein. The cradle 22 is further configured so that the leash 12 is slidably receivable through at least a portion of an outer periphery 26 thereof, so that folding the leash 12 about the outer periphery 26 engages the ball 24 in the cradle 22, wherein the pet accessory 10 is generally usable to lead an animal and as a sling to cast the ball 24, described below.

The skilled addressee will appreciate that by the elastic resiliently deformable cradle 22 being slidably arranged on the leash 12 allows the cradle 22 to be moved to either the proximal 18 or distal 14 ends of the leash 12 in order to function as a ball carrier when the pet accessory 10 is used as a leash. The cradle 22 is similarly moveable to a central portion of the leash 12, as required, when the leash is used as a sling.

The distal end 14 is typically configurable to engage an animal by including a leash clip 28. In another embodiment, the distal end 14 may be configurable to engage an animal by defining an aperture for fitment around a neck of an animal, or the like.

The finger loop 16 is typically shaped and dimensioned to operatively receive a finger of a user therein in order to secure the pet accessory 10 to a user's hand 30 to facilitate casting the ball 24 as a sling. The finger loop 16 is generally positioned on the leash 12 so that the leash clip 28 lies and is comfortably graspable in a palm of a user's hand 30 while a finger, typically an index finger 32, of the hand 30 is received by the finger loop 16.

In the exemplified embodiment, the handle 20 comprises a wrist loop 34 through which a wrist of a user is operatively passable. The handle 20 is generally shaped and dimensioned to be comfortably graspable by a thumb 33 of the user while the leash clip 28 lies and is comfortably graspable in a palm of a user's hand 30 while an index finger 32 of the hand 30 is received by the finger loop 16 in order to facilitate usability as a sling.

The elastic resiliently deformable cradle 22 is generally manufactured from a polymer and/or rubber material. The cradle 22 is shaped and dimensioned to provide an interference fit to a conventional ball, such as a tennis ball, a squash ball, etc. The skilled addressee will appreciate that the cradle 22 may be shaped and dimensioned to provide an interference fit to a plurality of conventional balls, such as a tennis ball, a squash ball, a golf ball, etc.

The outer periphery 26 of the elastic resiliently deformable cradle 22 generally defines at least two slits 36 therein so that the leash 12 is slidably receivable therethrough. However, other versions and configurations are possible and within the scope of the disclosure.

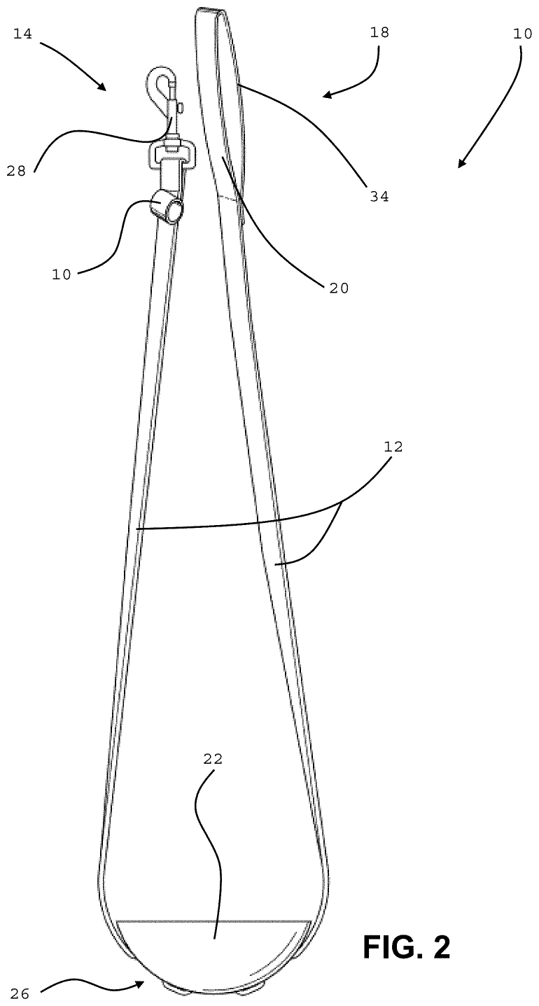

In general use, the pet accessory 10 is able to function as a conventional lead or leash to lead an animal. When used as a sling, the elastic resiliently deformable cradle 22 is moved to a middle of two lengths of the leash 12, as shown in FIG. 2. The index finger 32 is placed through the finger loop 16 on the distal end 14 and the handle 20 at the proximal end 18 is grasped between the thumb 33 and index finger 32. In this arrangement, the pet accessory 10 is swung in an arc, and the handle 20 released at a precise moment. This frees the ball to fly away or be cast to a target area, or the like. The sling essentially works by extending the length of a human arm, thus allowing the ball 24 to be thrown much farther than it generally could be by hand 30 alone.

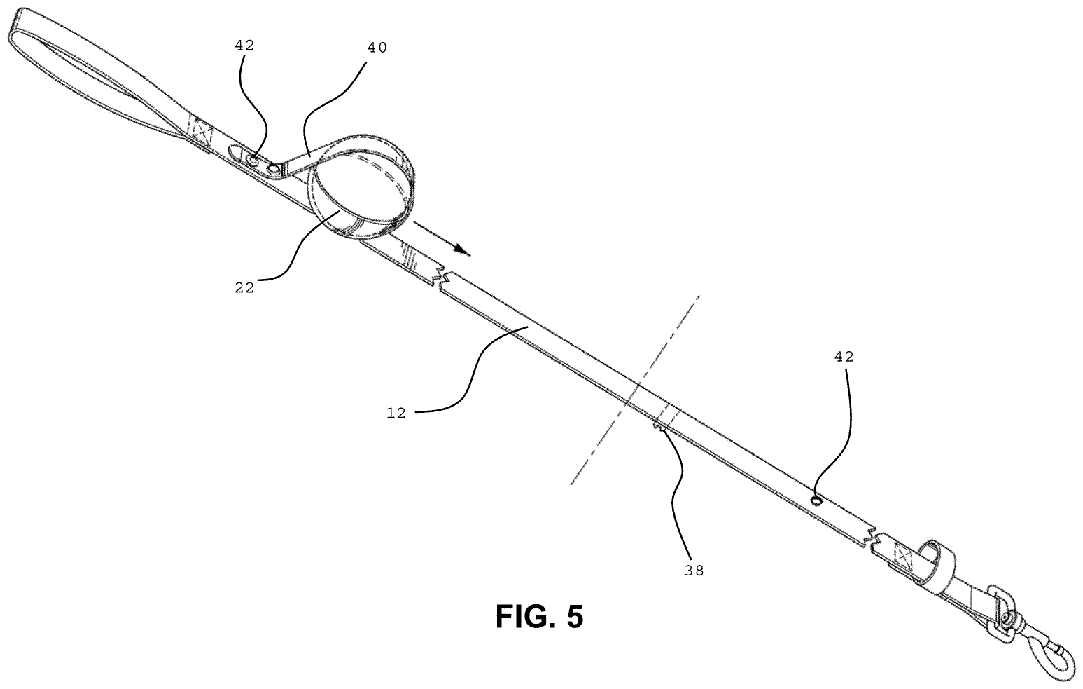

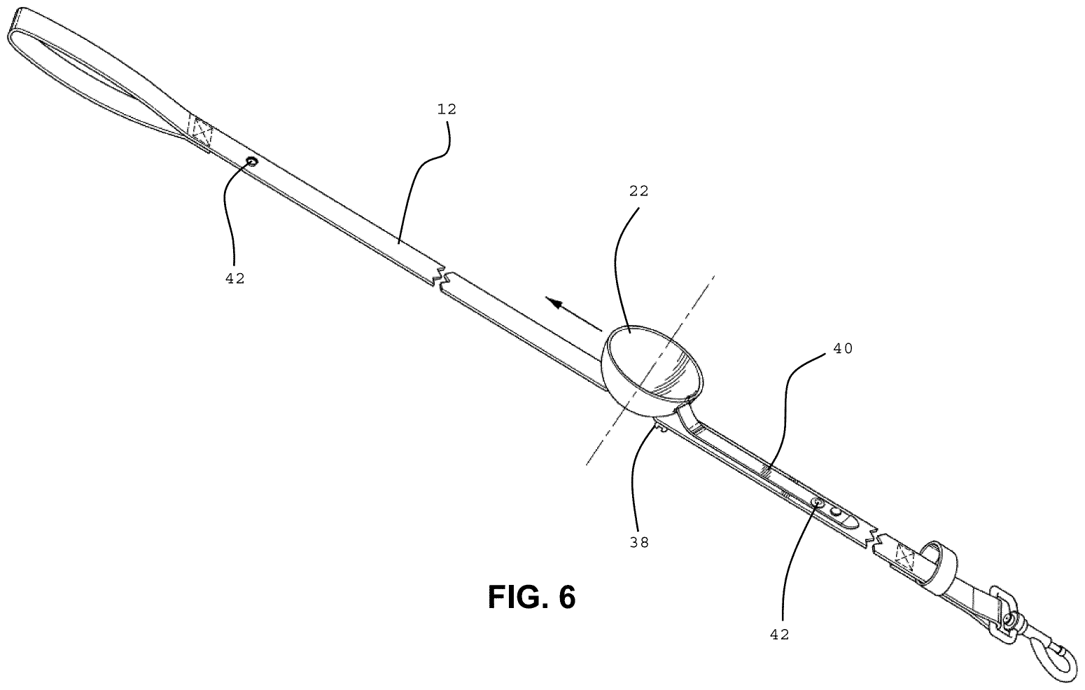

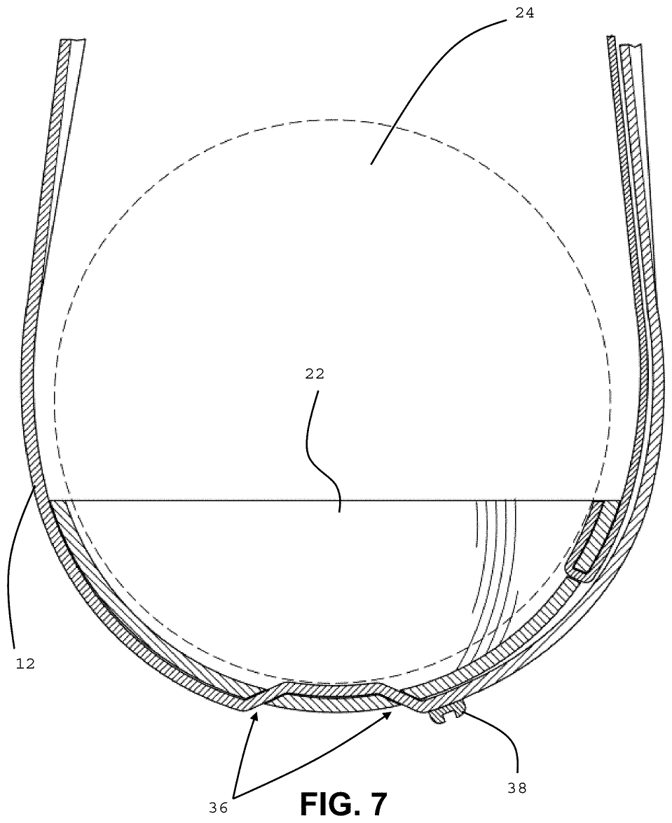

Referring now to FIGS. 5 to 9 of the accompanying drawings, there is shown a further embodiment of the pet accessory 10 wherein the leash 12 includes a stopper 38 configured to retain the elastic resiliently deformable cradle 22 at a certain position along a length of the leash 12. The stopper 38 is typically adjustable and used to retain the cradle at a midpoint of the leash to facilitate use as a sling when the cradle is not stored proximate the handle 20 or the distal end 14 of the leash 12.

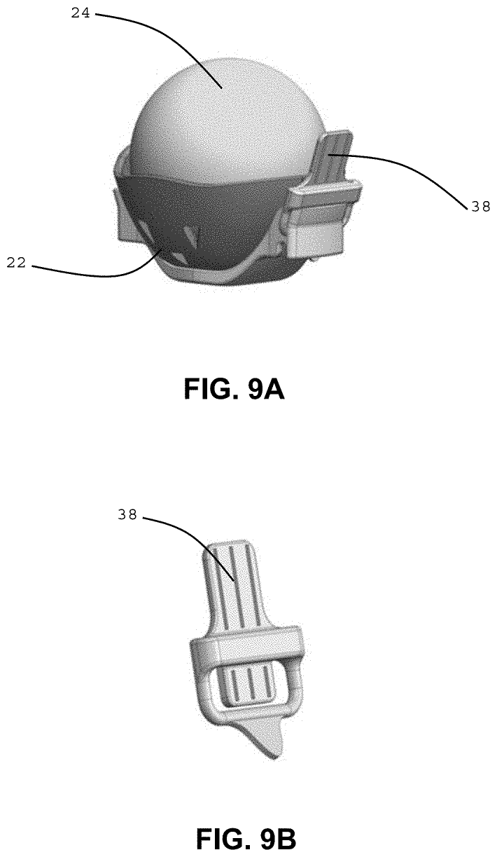

In the embodiment shown in FIGS. 9A and 9B, the stopper 38 comprises a clip to prevent the elastic resiliently deformable cradle 22 from traveling both up or down the leash 12 when used as a sling. The stopper 38 is generally sewn or fixable along the leash 12 and is attachable to the outside of the cradle from the finger loop side. When used as a leash for walking a dog, the stopper 38 can be released from the cradle 22 allowing the cradle 22 to be slid toward the handle, or the like.

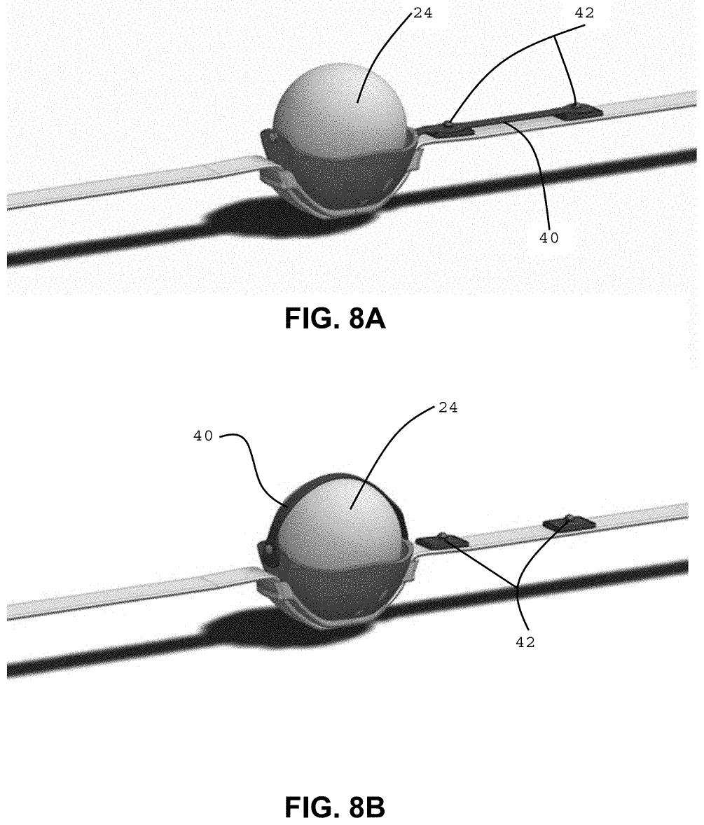

In addition, in this embodiment, the leash 12 includes a securing means 40, such as a suitable strap, which is configured to secure the ball 24 in the elastic resiliently deformable cradle 22, as shown. In one embodiment, the securing means 40 includes interference fit fasteners 42 whereby the securing means 40 is fixable to the leash 12 to either retain the ball 24 in the cradle 22, or to secure the securing means 40 out of the way when the leash 12 is used as a sling, as described above. Such interference fit fasteners 42 may include press studs, buttons, hook and loop fasteners, or the like. FIGS. 8A and 8B show another embodiment of such securing means 40 and the skilled addressee is to appreciate that variations hereon are possible and within the scope of the disclosure. .

Applicant believes a particularly advantageous embodiment of the disclosure provides for pet accessory 10, which enables use as a leash and ball carrier, while also usable as a ball sling in order to entertain and play with an animal, such as a dog.

Optional embodiments of the disclosure may also be said to broadly consist in the parts, elements and features referred to or indicated herein, individually or collectively, in any or all combinations of two or more of the parts, elements or features, and wherein specific integers are mentioned herein that have known equivalents in the art to which the disclosure relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a,” “an,” “said,” “the,” and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be appreciated that reference to “one example” or “an example” of the disclosure, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the disclosure, while other aspects are exemplified in a different example. These examples are intended to assist the skilled person in performing the disclosure and are not intended to limit the overall scope of the disclosure in any way unless the context clearly indicates otherwise. Variations (e.g., modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1. A pet accessory comprising:
a leash having a distal end configurable to engage an animal and further defining a finger loop, a proximal end defining a handle; and
an elastic resiliently deformable cradle manufactured from one or more of a polymer and rubber material, the elastic resiliently deformable cradle shaped and configured for operatively receiving a ball therein, the elastic resiliently deformable cradle shaped and dimensioned to provide an interference fit to the ball, the elastic resiliently deformable cradle further configured so that the leash is slidably receivable through at least a portion of an outer periphery thereof so that folding the leash about the outer periphery engages the ball in the elastic resiliently deformable cradle, wherein the pet accessory is usable to lead an animal and as a sling to cast the ball.

2. The pet accessory of claim 1, wherein the distal end is configurable to engage an animal by including a leash clip.

3. The pet accessory of claim 1, wherein the distal end is configurable to engage an animal by defining an aperture for fitment around a neck of an animal.

4. The pet accessory of claim 1, wherein the finger loop is shaped and dimensioned to operatively receive a finger of a user therein in order to secure the pet accessory to the user's hand to facilitate casting the ball as a sling.

5. The pet accessory of claim 2, wherein the finger loop is positioned on the leash so that the leash clip lies and is comfortably graspable in a palm of a user's hand while a finger on the user's hand is received by the finger loop.

6. The pet accessory of claim 1, wherein the handle comprises a wrist loop through which a wrist of a user is operatively passable.

7. The pet accessory of claim 2, wherein the handle is shaped and dimensioned to be comfortably graspable by a thumb of a user while the leash clip lies and is comfortably graspable in a palm of the user's hand while an index finger on the user's hand is received by the finger loop in order to facilitate usability as a sling.

8. The pet accessory of claim 1, wherein the ball is chosen from a tennis ball, a squash ball, and a golf ball.

9. The pet accessory of claim 1, wherein the outer periphery of the elastic resiliently deformable cradle defines at least two slits therein so that the leash is slidably receivable therethrough.

10. The pet accessory of claim 1, wherein the leash includes a stopper configured to retain the elastic resiliently deformable cradle at a certain position along a length of the leash.

11. The pet accessory of claim 10, wherein the stopper is adjustable.

12. The pet accessory of claim 1, wherein the leash includes a securing means configured to secure the ball in the elastic resiliently deformable cradle.

13. The pet accessory of claim 12, wherein the securing means includes interference fit fasteners whereby the securing means is fixable to the leash to either retain the ball in the cradle, or to secure the securing means to avoid interference when the leash is used as a sling.

14. A pet accessory comprising an elastic resiliently deformable cradle of claim 1, the elastic resiliently deformable cradle receivable on a leash so that the leash with accessory is usable to lead an animal and as a sling to cast a ball.

15.-17. (canceled)
